(19) United States
(12) Patent Application Publication
(10) Pub. No.: US 2017/0314399 A1
(43) Pub. Date: Nov. 2, 2017

(54) LONG, CONTINUOUS ENGRAVING ALONG A ROW OF COOLING HOLES

(71) Applicant: Siemens Aktiengesellschaft, München (DE)

(72) Inventors: Fathi Ahmad, Kaarst (DE); Christian Menke, Essen (DE)

(73) Assignee: Siemens Aktiegesellschaft, Munchen (DE)

(21) Appl. No.: 15/528,866

(22) PCT Filed: Nov. 2, 2015
(86) PCT No.: PCT/EP2015/075390

§ 371 Date: May 23, 2017

(30) Foreign Application Priority Data
Dec. 2, 2014 (EP) 14195844.7

(51) Int. Cl. F01D 5/18; F01D 9/02; C23C 28/00; F01D 5/28

(52) U.S. Cl. CPC F01D 5/186; F01D 5/288; F01D 9/02; C23C 28/30; F05D 2300/175; F05D 2300/20; F05D 2300/611; F05D 2260/202

(57) ABSTRACT

By continuously long engravings, the spallation behavior of the thermal barrier coating is reduced and the lifetime of the TBC is prolonged.

### CROSS-REFERENCE TO RELATED APPLICATIONS

This application claims priority to PCT Application No. PCT/EP2015/075390, having a filing date of Nov. 2, 2015, based off of European application No. EP 14195844.7 having a filing date of Dec. 2, 2014, the entire contents of which are hereby incorporated by reference.

### FIELD OF TECHNOLOGY

This following relates to a ceramic surface structure, wherein a long engraving is present along a row of cooling holes.

### BACKGROUND

The highly loaded turbine blades and vanes require the application of different protection technologies in order to be able to withstand the high thermal loading. The front stages of the turbine blades and vanes require a ceramic coating and the film cooling technology as well as the internal cooling.

The application of such technologies is helpful as long as the combination works during operation and no spallation occurs or nor cooling holes blockage is noticed.

The manufacturing of the film cooling holes could be one of the reasons for the ceramic coating spallation.

Parameters of the laser drilling causes cracks within the ceramic coating, which later spalls down and restricts the operation of the component.

On the other hand it is not possible to reduce the laser drilling energy to a very low level due to the fact that no drilling will take place with low energy.

### SUMMARY

An aspect relates to improving the lifetime of a ceramic coating and preventing the overall spallation of a TBC.

### BRIEF DESCRIPTION

Some of the embodiments will be described in detail, with reference to the following figures, wherein like designations denote like members, wherein:

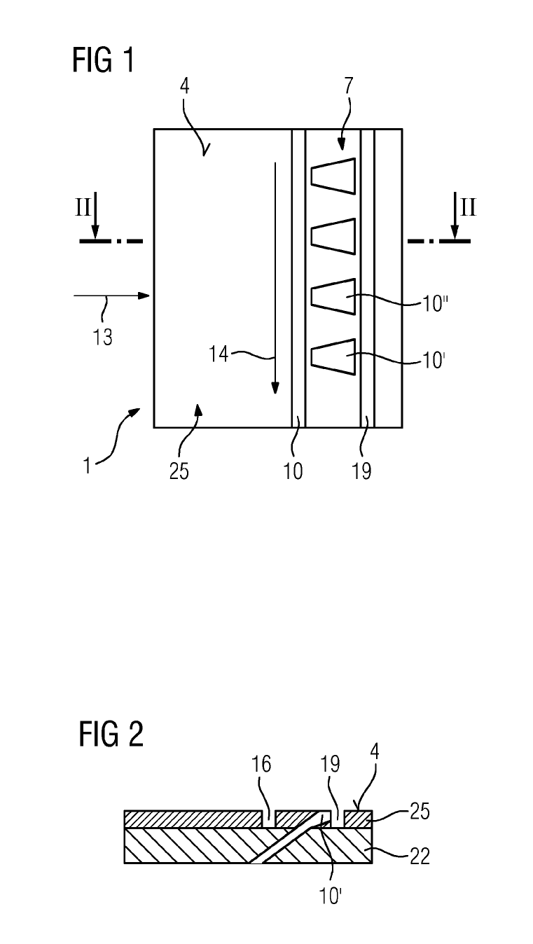

FIG. 1 depicts a view on top of a surface of a TBC and a row of cooling holes, in accordance with embodiments of the present invention;

FIG. 2 depicts a cross-section area of FIG. 1, in accordance with embodiments of the present invention;

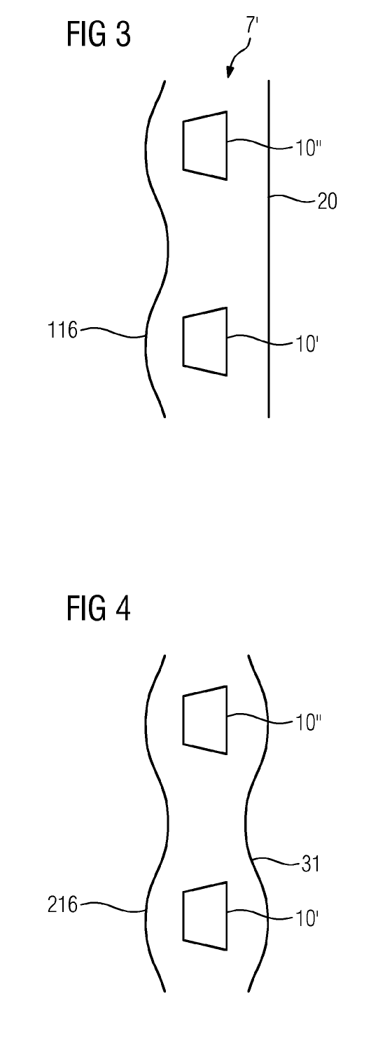

FIG. 3 depicts a view of a first embodiment of a curved form of an engraving, in accordance with embodiments of the invention; and

FIG. 4 depicts a view of a second embodiment of a curved form an engraving, in accordance with embodiments of the invention.

### DETAILED DESCRIPTION

By an implementation of a polymer masking it is possible to introduce the suggested design in FIGS. 1-4. The polymer masking will provide a ceramic free region along the cooling holes.

This manufacturing procedure has following advantage:

The engraving will not reduce the bond coat thickness as during a laser engraving

This step can be carried out during the coating

In case of casting and coating deviations, the polymer masking will not affect the bond coat thickness.

The width of such a ceramic free region could vary between 1 and 2 mm.

The positive effect of the engraving is the spallation behavior. In case of spallation the spalled region will not be extended on wide regions.

Another positive effect of the engraving is the vortices introduced due to the no-APS regions, which forces the hot gas flow to stick to the wall as by the dimples on a golf ball. During operation the step within the ceramic coating will be smoothened as well as the APS smoothening procedure will help breaking the edges.

The following positive effects are related to the engraving:

Retrofitable with current designs

In case of spallation, only restricted region will be affected

Lower operation risk

Reduced rework after laser drilling

Applicable to all spallation threatened cooling holes rows

Applicable to vanes and blades.

FIG. 1 shows a view on the top of a ceramic coating 25 (FIG. 2). The thermal barrier coating 25 (TBC) is part of a component 1 which has a substrate 22 (FIG. 2) wherein on top of the substrate 22 the thermal barrier coating 25 is applied. This component 1 has at least one row 7 of cooling holes 10′, 10″, . . . , which are during use of the component 1 overflowed by hot gas according the arrow 13, especially almost perpendicular to the direction 14 of the row 7. The direction 14 is straight or has only one or two times a break of slope of maximum 25°.

Along the direction 14 of the row 7 of the cooling holes 10′, 10″, . . . there is especially only before the row 7 an engraving 16 and/or after the row 7 a second engraving 19.

These engravings 16, 19 are continuous, especially straight engravings in the TBC 25.

The engravings 16, 19, 20, 116, 216, 31 (FIG. 3, 4) are not endless, e. g. not a circle or not a square or not closed looped.

The engravings 16, 19, 20, 116, 216, 31 start especially at the beginning and end at the end of a row 7.

The distance between two engravings 16, 19, 20, 116, 216, 31 before and after the one row 7 next to each other is especially 1 mm to 2 mm.

Furthermore the engravings can also arranged only in the TBC 25.

In FIG. 2 it can be seen that the engravings 16, 19 have a depth until the substrate 22.

But nevertheless the surface of the substrate 22 can be coated with a metallic bond coat like a NiCoCrAl plus optional additives (Y, Re, Si, Ta, . . . ).

FIGS. 3, 4 show a curved form of the engravings 20, 116, 216, 31, wherein the distance of opposite curved engraving 116, 20; 216, 31 is smaller between two cooling holes 10′, 10″ and which are not straight (FIG. 4), but multiple curved or a combination of it (FIG. 3).

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A component comprising:
a substrate,
a ceramic thermal barrier coating on the substrate;
at least one row of cooling holes along a direction in the substrate and in the ceramic thermal barrier coating, wherein the ceramic thermal barrier coating has at least one engraving, wherein the at least one engraving is a long continuous engraving along the direction before and/or after of the at least one row.

2. The component according to claim 1, wherein the at least one engraving is straight.

3. The component according to claim 1, wherein the at least one engraving includes multiple curves.

4. The component according to claim 1, wherein the at least one engraving is long and continuous and which is not connecting with each other or endless.

5. The component according to claim 1, wherein the at least one engraving is arranged in the thermal barrier coating.

6. The component according to claim 1, wherein the at least one engraving is only arranged before and after one row.

7. The component according to claim 1, wherein the substrate has a metallic overlay coating.

8. The component according claim 7, wherein the at least one engraving has a depth that reaches an outer surface of a metallic coating on the substrate.

9. The component according to claim 1, wherein the at least one engraving is only arranged in the ceramic thermal barrier coating and does not reach the substrate or a metallic coating.

10. The component to claim 1, wherein the at least one engraving starts at a beginning and an end at an end of a row.

11. The component to claim 1, wherein both engravings have a distance to each other along an overflow direction of 1 mm to 2 mm.

12. The component to claim 11, wherein the distance of a curved engraving to a straight engraving or to a curved engraving is smaller between two cooling holes of these two engravings.

13. The component according to claim 1, wherein the substrate is a nickel- or cobalt-based super alloy.
